(19) United States
(12) Patent Application Publication
(10) Pub. No.: US 2008/0143153 A1
(43) Pub. Date: Jun. 19, 2008

(54) Seat rod of a bicycle

(76) Inventor: Sheng-Chen Lin, Taichung (TW)

Correspondence Address: SHENG-CHEN LIN, 235 Chung - Ho, Box 8-24, Taipei, omitted

(21) Appl. No.: 11/585,273

(22) Filed: Oct. 24, 2006

(51) Int. Cl. B62J 1/00

(52) U.S. Cl. 297/195.1

(57) ABSTRACT

A seat rod of a bicycle, comprises a seat rod having an assembly portion at a top end thereof; a lateral side of the assembly portion having a first sliding groove; and a top of the assembly portion having a second sliding groove which is communicated to the first sliding groove; a connecting unit for clamping a cushion of a bicycle; the connecting unit being installed with a pin so that the connecting unit is slideable installed in the second sliding groove; and a driving unit including a handle and an eccentric rod inserted into the first sliding groove. When the handle of the driving unit is driven, the handle will at a position of releasing or tightening, then the driving unit slides along the first sliding groove and the connecting unit is driven to slide.

### FIELD OF THE INVENTION

The present invention relates to bicycles, and particularly to a seat rod of a bicycle, wherein the cushion is adjusted easily and quickly in a horizontal position.

### BACKGROUND OF THE INVENTION

Generally, a middle section of a bicycle has a seat tube. A seat rod is inserted into the seat tube. A top of the seat rod has a cushion which is provided to the driver for seating thereon. A connecting unit serves to fix the cushion and the seat rod. In one prior art, the cushion is clamped by an upper cover and a lower cover by screwing so that the cushion is fixed to the seat rod. Thus the elevation of the cushion is adjustable.

However, the prior art has the follow defects. The adjustment of the cushion is performed by a spanner. Thus the operation is inconvenient and time and labor are consumed.

### SUMMARY OF THE INVENTION

Accordingly, the primary object of the present invention is to provide a seat rod of a bicycle, wherein the cushion is adjusted easily and quickly in a horizontal position.

Advantages of the present invention are that in adjustment of the position of the cushion, it is only necessary to pull a retaining unit and then a driving unit is driven so as to move the cushion. When it is desired to fix the cushion, the driving unit is driven so that the driving unit is fixed by the retaining unit. The operation is quick and simple for a driver.

To achieve above objects, the present invention provides a seat rod of a bicycle which comprises a seat rod having an assembly portion at a top end thereof; a lateral side of the assembly portion having a first sliding groove; and a top of the assembly portion having a second sliding groove which is communicated to the first sliding groove; a connecting unit for clamping a cushion of a bicycle; the connecting unit being installed with a pin so that the connecting unit is slideable installed in the second sliding groove; and a driving unit including a handle and an eccentric rod inserted into the first sliding groove. When the handle of the driving unit is driven, the handle will at a position of releasing or tightening, then the driving unit slides along the first sliding groove and the connecting unit is driven to slide.

The various objects and advantages of the present invention will be more readily understood from the following detailed description when read in conjunction with the appended drawing.

### BRIEF DESCRIPTION OF THE DRAWINGS

FIG. 1 is an exploded schematic view of the seat rod of a bicycle of the present invention.

FIG. 2 is an assembled cross sectional view of the seat rod of a bicycle of the present invention.

FIGS. 3 and 4 are a schematic view showing the operation of the retaining unit of the seat rod of a bicycle of the present invention.

FIG. 5 is an assembled schematic view of the seat rod of a bicycle of the present invention.

FIGS. 6 to 8 are schematic views showing the operation of the seat rod of a bicycle of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

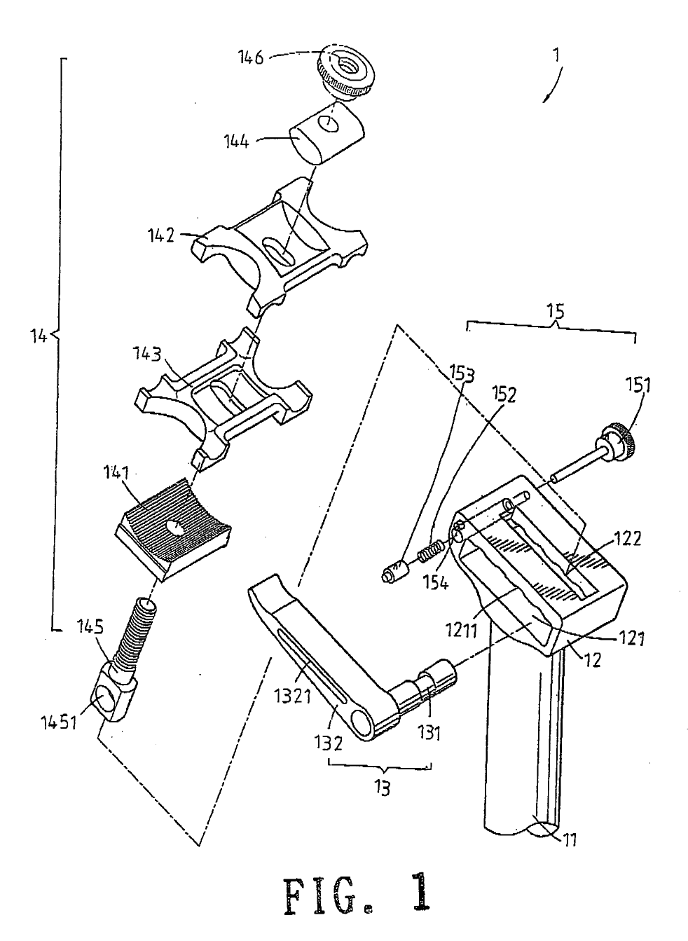

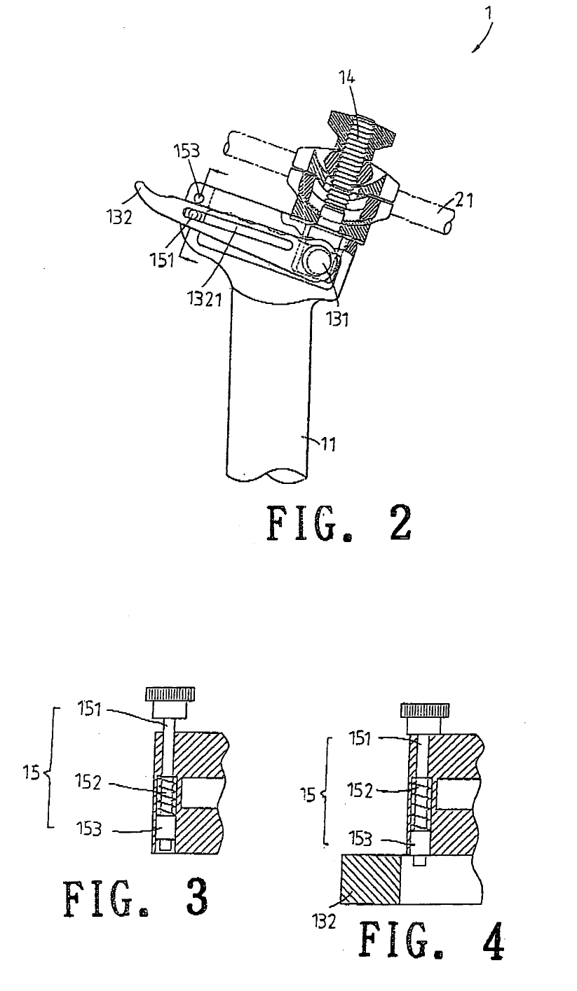

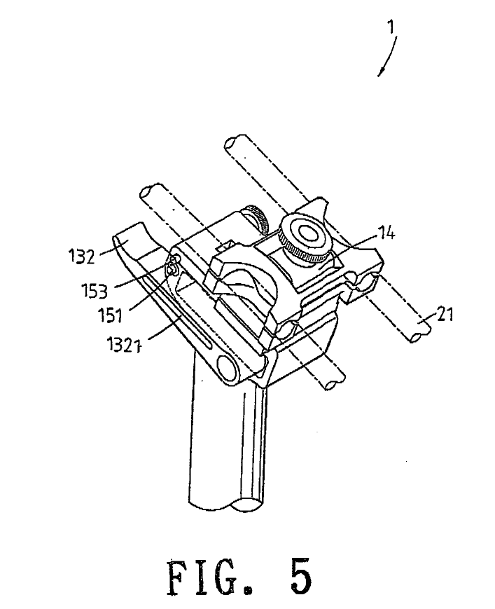

Referring to FIG. 1 to 5, the seat of the present invention is illustrated. The bicycle seat of the present invention has the following elements.

A seat rod 11 is inserted into a seat tube (not shown) of a bicycle.

An assembly portion 12 is installed at a top of the seat rod 11. A first sliding groove 121 is formed at one lateral side of the assembly portion 12. An upper side of the first sliding groove 121 is formed with a plurality of recesses 1211. A top surface of the assembly portion 12 is installed with a second sliding groove 122 which is communicated to the first sliding groove 121. A retaining unit 15 is installed on the assembly portion 12. The retaining unit 15 has a fixing rod 151. An elastic unit 152 encloses the fixing rod 151. An engaging unit 153 is installed at one end of the fixing rod 151. The elastic unit 152 is slideable in the assembly portion 12. The assembly portion 12 is installed with a stop block 154 near the engaging unit 153 of the fixing rod 151.

A driving unit 13 is positioned in the recesses 1211 of the assembly portion 12 and is fixed by the retaining unit 15. The driving unit 13 is fixed by the stop block 154. One end of the driving unit 13 is formed with an eccentric rod 131. The eccentric rod 131 has a long axis and a short axis. When the long axis of the eccentric rod 131 rotates to be parallel to the seat rod 11, the connecting unit 14 is fixed. When the short axis of the eccentric rod 131 rotates to be parallel to the seat rod 11, the connecting unit 14 is released. The eccentric rod 131 is inserted into the first sliding groove 121. Another end of the driving unit 13 has a handle 132. The handle 132 is formed with a positioning hole 1321. The retaining unit 15 is inserted into the positioning hole 1321 so as to fix the driving unit 13.

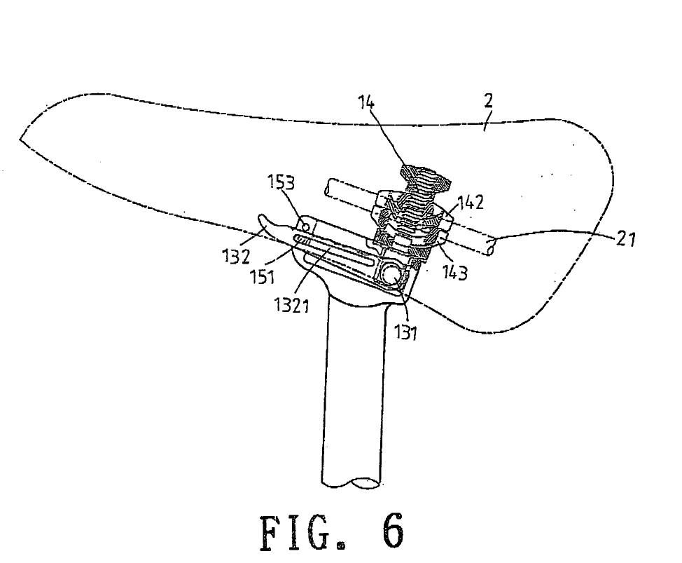

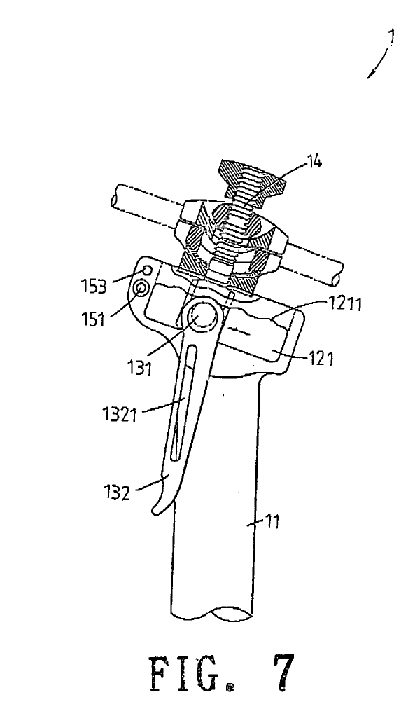

A connecting unit 14 has a base 141. The eccentric rod 131 is inserted into the first sliding groove 121. A lower cover 143 is installed on the base 141. An upper cover 142 is installed upon the lower cover 143. Two seat arcs 21 of a cushion 2 are installed between the upper cover 142 and the lower cover 143 (FIG. 6) for fixing the cushion 2. A retaining block 144 is installed on the upper cover 142. A pin 145 passes through the base 141, lower cover 143, upper cover 142 and the retaining block 144 and then is pivotally installed to a pivotal ear 146. The pin 145 has a pivotal hole 1451. When the pin 145 is inserted into the second sliding groove 122, the eccentric rod 131 passes through the pivotal hole 1451 to drive the driving unit 13 to slide in the eccentric rod 131. When the driving unit 13 is rotated, the eccentric rod 131 and the pivotal hole 1451 are moved so that the connecting unit 14 is fixed or release.

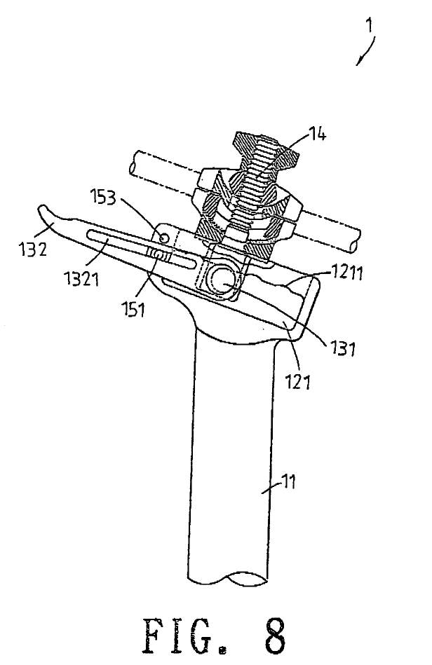

In use of the present invention, referring to FIGS. 6 to 8, two seat arcs 21 of the cushion 2 are fixed to be between the upper cover 142 and the lower cover 143 of the connecting unit 14. The seat rod 11 passes through a seat tube (not shown) of a bicycle. When it is desired to move the cushion 2, the retaining unit 15 is pulled outwards. The fixing rod 151 will separate from the positioning hole 1321 so that the handle 132 will drive the eccentric rod 131 to rotate. Thus the short axis of the eccentric rod 131 will rotate to be parallel to the seat rod 11, while a gap is formed between the eccentric rod 131 and the pivotal hole 1451. Thus, the connecting unit 14 will release. The connecting unit 14 moves to drive the driving unit 13 to slide in the first sliding groove 121 and the second sliding groove 122. Thus, the eccentric rod 131 will enter into the recess 1211. If it is desired to fix the connecting unit 14, the retaining unit 15 is pulled outwards. Then the handle 132 is driven toward the stop block 154 so that the handle 132 will resist against the stop block 154. When the fixing rod 151 is released, the elastic unit 152 will return the fixing rod 151 so that the fixing rod 151 passes through the positioning hole 1321. Then the long axis of the eccentric rod 131 rotates to be parallel to the seat rod 11. Thus it resists against the pivotal hole 1451 to fix the connecting unit 14. Thereby the effects of moving and fixing the cushion 2 are achieved.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A seat rod of a bicycle, comprising:
a seat rod having an assembly portion at a top end thereof; a lateral side of the assembly portion having a first sliding groove; and a top of the assembly portion having a second sliding groove which is communicated to the first sliding groove;
a connecting unit for clamping a cushion of a bicycle; the connecting unit being installed with a pin so that the connecting unit is slideable installed in the second sliding groove; and
a driving unit including a handle and an eccentric rod inserted into the first sliding groove; and
wherein when the handle of the driving unit is driven, the handle will at a releasing state or at a tightening state, then the driving unit slides along the first sliding groove and the connecting unit is driven to slide.

2. The seat rod of a bicycle as claimed in claim 1, wherein one side of the second sliding groove is formed with a plurality of recesses for positioning the driving unit at different locations.

3. The seat rod of a bicycle as claimed in claim 1, wherein one end of the assembly portion passes through a retaining unit and the driving unit will resist against the retaining unit as the driving unit is at a tightening position.

4. The seat rod of a bicycle as claimed in claim 3, wherein the retaining unit is installed on the assembly portion; the retaining unit has a fixing rod; an elastic unit encloses the fixing rod; an engaging unit is installed at one end of the fixing rod; the elastic unit is slideable in the assembly portion; and the assembly portion is installed with a stop block near the engaging unit of the fixing rod.

5. The seat rod of a bicycle as claimed in claim 1, wherein the pin passes through the base, a lower cover, an upper cover and the retaining block and then is pivotally installed to a pivotal ear; the pin has a pivotal hole for receiving the driving unit so that the driving unit is slideable in the assembly portion.
